(19) United States
(12) Patent Application Publication
(10) Pub. No.: US 2016/0288805 A1
(43) Pub. Date: Oct. 6, 2016

(54) Side Window for a Passenger Compartment in a Vehicle

(71) Applicant: SIEMENS AG ÖSTERREICH, Wien (AT)

(72) Inventor: Thomas BACHMAYER, Wien (AT)

(21) Appl. No.: 15/038,176

(22) PCT Filed: Oct. 13, 2014
(86) PCT No.: PCT/EP2014/071845

§ 371 Date: May 20, 2016

(30) Foreign Application Priority Data
Dec. 4, 2013 (EP) 13195606.2

(51) Int. Cl. B61D 25/00; E06B 9/24; H02J 7/35; B61D 1/00; H02S 40/22

(52) U.S. Cl. CPC B61D 25/00; B61D 1/00; H02S 40/22; H02J 7/355; E06B 9/24; E06B 2009/2476; E06B 2009/2417

(57) ABSTRACT

A side window for a passenger compartment in a vehicle, in particular a rail vehicle, includes a single-pane glass and reflector slats that are embedded in the single-pane glass, where the distance between adjacent reflector slats as well as an angle of inclination between each reflector slat and the plane of the single-pane glass are predefined.

### CROSS-REFERENCE TO RELATED APPLICATIONS

This is a U.S. national stage of application No. PCT/EP2014/071845 filed 13 Oct. 2014. Priority is claimed on European Application No. 13195606 filed 4 Dec. 2013, the content of which is incorporated herein by reference in its entirety.

### BACKGROUND OF THE INVENTION

1. Field of the Invention

The invention relates to a passenger compartment side window for a vehicle, in particular a rail vehicle, having single or double glazing.

2. Description of the Related Art

A passenger compartment in a public means of transport is the area of the vehicle in which the passengers are accommodated. When the vehicle is used in subtropical and tropical climate zones, solar radiation entering the passenger compartment through large-area side windows causes undesirable heating. Particularly in the case of rail vehicles making frequent stops in bright sunlight conditions, climate control of the interior requires a correspondingly large-dimensioned air conditioning system. This increases the rail vehicle's manufacturing costs. The comparatively heavy weight of the air conditioning unit together with the increased energy requirement for climate control result in increased operating costs.

In order to shield the passenger compartment of a rail vehicle from incident solar radiation, it is known to double-glaze vehicle windows, or mount a roller or venetian blind on the inside of the passenger compartment side windows. Although this largely shields the passengers from incident sunlight, only a small amount of the heat radiation incident on the roller and venetian blind can be kept out of the car interior.

For rail vehicles, glass systems are also known in which a solar and thermal insulation coating is applied to a safety glass. However, in the case of harsh environmental conditions and extremely high UV radiation, the functional coating may become damaged during its service life, thereby reducing the insulating effect and entailing corresponding maintenance work.

### SUMMARY OF THE INVENTION

In view of the foregoing, it is therefore an object of the present invention to provide a passenger compartment side window for a vehicle, in particular for a rail vehicle, whereby the influx of solar energy is reduced and the window can be manufactured inexpensively.

This and other objects and advantages are achieved in accordance with the invention in which the passenger compartment side window is fitted with reflector slats which are either directly embedded in the pane at a fixed spacing and angle of tilt, or disposed in the cavity between double glazing panes. As a result, the solar radiation incident on a reflector slat inclined outward at an angle of tilt is reflected such that it does not enter the passenger compartment. The solar energy influx into the interior of the vehicle is therefore comparatively lower. The spacing between reflector slats is configured such that, on the one hand, the ability to see through the window from inside the passenger compartment is not too severely limited but, on the other hand, incident solar rays are reliably reflected to the outside. The spacing between the individual slates can vary in magnitude, likewise the angle of tilt. It appears advantageous merely that, for reasons of simplicity, both the spacing and angle of tilt are fixed.

It can be particularly advantageous if each reflector slat is simultaneously formed as a solar slat. Thus, on the one hand a shading function is achieved, and, on the other, the incident solar radiation is converted into solar energy.

Here, it can be particularly advantageous if the electrical energy thus obtained from solar energy is used, e.g., for battery charging. The greater the intensity of the solar radiation, the more energy is available for battery charging. The solar charging power can make a significant contribution to the standby operation of a train.

A major advantage of this contemplated embodiment of the invention is therefore that the shading effect of the reflector slats can not only greatly reduce the energy influx into the vehicle interior, but energy for electrical loads can also be obtained.

It is also an object of the invention to provide a rail vehicle which is fitted with passenger compartment side windows as described above.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

For further explanation of the invention, reference will be made in the following section of the description to drawings in which other exemplary embodiments, details and further developments of the invention are set forth on the basis of non-limiting examples, in which:

FIG. 1 shows a schematic partial cross section through the passenger compartment of a rail vehicle, where in accordance with an exemplary embodiment of the invention reflector slats are embedded in a pane of a passenger compartment side window;

FIG. 2 shows a schematic partial cross section through the passenger compartment of a rail vehicle, where in accordance with an exemplary embodiment of the invention reflector slats are disposed in a cavity between two double-glazing panes; and

FIG. 3 shows a schematic block diagram of another embodiment of the invention, where the individual reflector slats are also framed as solar cells and the electrical energy thus obtained is used for operating secondary loads, e.g., for charging a battery.

### DETAILED DESCRIPTION OF THE EXEMPLARY EMBODIMENTS

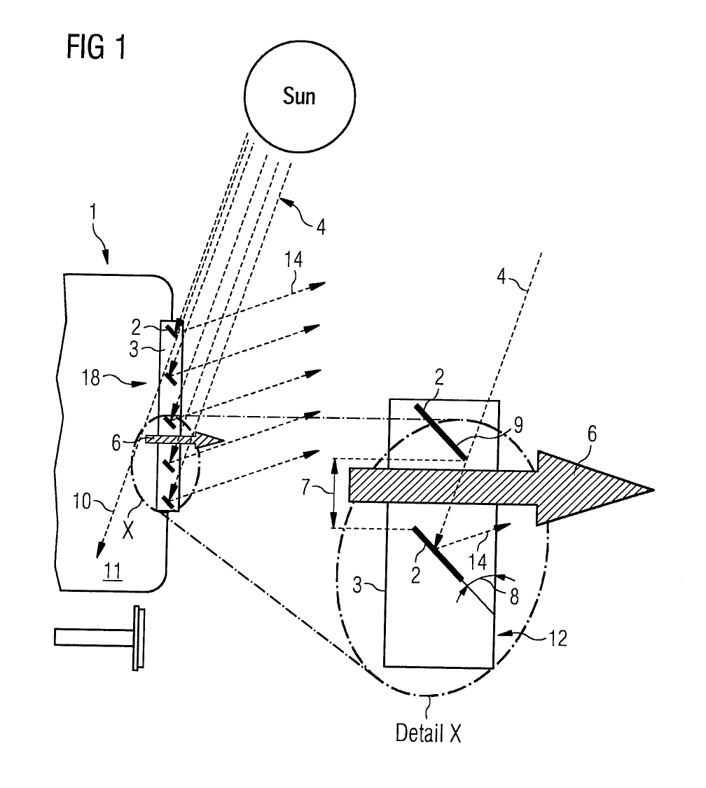

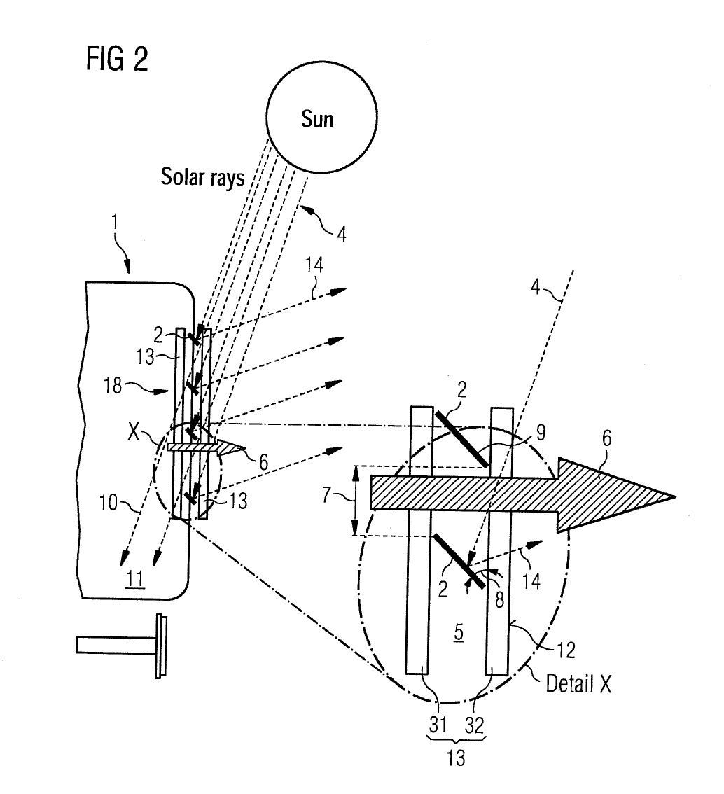

FIG. 1 shows a schematic partial cross section of a rail vehicle 1 comprising a passenger compartment 11. A passenger compartment side window 18 is depicted on a side wall of the passenger compartment 11. In the exemplary embodiment shown, the passenger compartment side window 18 has a single glass pane 3 in which a plurality of reflector slats 2 are embedded. The reflector slats 2 are therefore molded into the glass body. The spacing 7 between adjacent reflector slats 2 is configured such that passengers can see through them horizontally (arrow 6). The reflector slats 2 do not therefore excessively limit transparency 6. As may be best seen in the detail X, the reflector slats 2 are inclined, i.e., subtend an angle 8 with the plane 12 of the pane. By suitably selecting the width of the slats 2, their spacing 7 with respect to one another and the angle 8, a large proportion of the incident solar rays 4 are reflected from the reflecting surface 9 of the respective reflector slat 2 (reflected solar radiation 14 in FIG. 1 and FIG. 2). Only a small proportion of the solar rays 10 enter the passenger compartment 11. As a result, the effect of the slats 2 is therefore that the influx of solar energy into the passenger compartment 11 is reduced. If the vehicle 1 is used in a subtropical or tropical region, the technical complexity for the air conditioning of the passenger compartment 11 is therefore lower. A lighter-weight air conditioning unit can be installed on the rail vehicle 1.

FIG. 2 shows another exemplary embodiment of the invention. Once again, a rail vehicle 1 having a passenger compartment 11 is shown in a schematic partial cross-sectional view, but in this case the passenger compartment side window 18 is not implemented as single pane of glass but as a double-glazed unit 13. As may be best seen from the detail X in FIG. 2, the double-glazed unit 13 essentially consists of two panes 31,32 and an intervening cavity 5. This cavity 5 again contains an arrangement of reflector slats 2. Here, the individual slats 2 are also disposed with a spacing 7 from one another and subtend an angle 8 with the plane 12 of the double-glazed unit 13. The ratios are again selected such that incident solar rays 4 are reflected back out from reflective surfaces 9 of the slats 2 (see reflected solar radiation 14 in FIG. 1 and FIG. 2). Only a greatly reduced proportion of the incident solar rays 10 reach the interior of the passenger compartment 11. Once again, the spacing 7 of the slats is configured such that the transparency 6 is not too severely limited for the passengers.

The feature common to both of the exemplary embodiments is that the spacing 7 and tilt angle 8 of the individual reflector slats 2 is fixed.

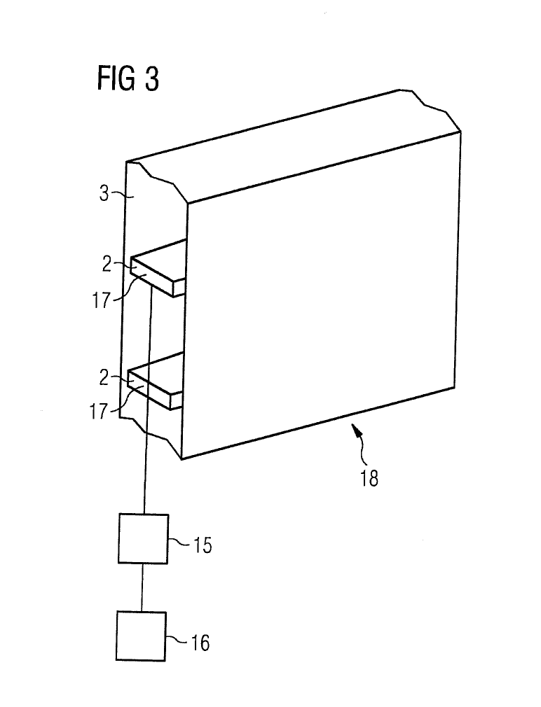

FIG. 3 shows another further embodiment of the invention, where the individual reflector slats 2 are also formed as solar slats 17. Each of the slats 2 therefore consists of an array of solar cells. The individual solar slats 17 are electrically connected to one another and to a control unit 15. Thus, on the one hand, shading is produced, and on the other hand, electrical energy that is supplied to a control unit 15 is obtained from the slats 2 formed as solar cells. The control unit 15 uses the solar energy, for example, for charging the battery 16.

Likewise, the reflector slats 2 disposed in the cavity 5 can be formed as solar slats 17 and used for battery charging, which is not shown in the drawing, however.

Although the invention has been illustrated and described in detail on the basis of the above mentioned preferred embodiments, the invention is not limited by the examples disclosed. Other variations may be inferred therefrom by those skilled in the art without departing from the scope of protection sought for the invention.

Thus, while there have been shown, described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements which perform substantially the same function in substantially the same way to achieve the same results are within the scope of the invention. Moreover, it should be recognized that structures and/or elements shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-4. (canceled)

5. A passenger compartment side window for a vehicle, comprising:
a single glass pane; and
reflector slats embedded in the single glass pane;
wherein a respective spacing between adjacent reflector slats and an angle of tilt subtended by each reflector slat with the plane of the pane is fixed.

6. A passenger compartment side window for a vehicle, comprising:
a double-glazed unit having a cavity; and
reflector slats which are disposed in the cavity of the double-glazed unit;
wherein a respective spacing between each adjacent reflector slat of the reflector slats and an angle of tilt subtended by each of the reflector slats with the plane of the double-glazed unit is fixed.

7. The passenger compartment side window as claimed in claim 6, wherein the vehicle is a rail vehicle.

8. The passenger compartment side window as claimed in claim 6, wherein each reflector slat is formed as a solar slat.

9. The passenger compartment side window as claimed in claim 6, wherein each reflector slat is formed as a solar slat.

10. The passenger compartment side window as claimed in claim 8, wherein the solar slat is electrically connected to a control device; and wherein electrical energy produced by the solar slat is supplied to a battery to charge the battery.

11. A rail vehicle having a passenger compartment, wherein side windows as claimed in claim 5 are implemented on side walls of said passenger compartment.

12. A rail vehicle having a passenger compartment, wherein side windows as claimed in claim 6 are implemented on side walls of said passenger compartment.

13. The passenger compartment side window as claimed in claim 6, wherein the vehicle is a rail vehicle.

14. The passenger compartment side window as claimed in claim 6, wherein the vehicle is a rail vehicle.
